(19) United States
(12) Patent Application Publication
(10) Pub. No.: US 2021/0012271 A1
(43) Pub. Date: Jan. 14, 2021

(54) DETECTION DEVICE, MANAGEMENT METHOD AND COMMUNICATION APPARATUS

(71) Applicant: KYOCERA Corporation, Kyoto-shi, Kyoto (JP)

(72) Inventors: Shigeki TANABE, Yokohama-shi, Kanagawa (JP); Yasuhiro UENO, Yokohama-shi, Kanagawa (JP); Hideki MORITA, Yokohama-shi, Kanagawa (JP); Isao MASUIKE, Machida-shi, Tokyo (JP); Koutaro YAMAUCHI, Yokohama-shi, Kanagawa (JP); Manabu SAKUMA, Yokohama-shi, Kanagawa (JP); Kenji SHIMADA, Yokohama-shi, Kanagawa (JP)

(21) Appl. No.: 16/978,124

(22) PCT Filed: Mar. 20, 2019
(86) PCT No.: PCT/JP2019/011757

§ 371 Date: Sep. 3, 2020

(30) Foreign Application Priority Data
Mar. 28, 2018 (JP) 2018-062990

(51) Int. Cl. G06Q 10/08; G06F 1/32; G07F 17/12

(52) U.S. Cl. CPC G06Q 10/083; G07F 17/12; G06F 1/32; G06Q 10/087

(57) ABSTRACT

A detection device includes a first sensor, a second sensor configured to operate with power consumption smaller than that of the first sensor and a controller. The controller obtains a detection result from the second sensor while stopping the first sensor. When a detection result of the second sensor meets a first condition, the controller operates the first sensor to obtain a detection result from the first sensor.

### CROSS-REFERENCE TO RELATED APPLICATION

This application claims priority to and benefit of Japanese Patent Application No. 2018-62990 filed on Mar. 28, 2018, the entire contents of which are incorporated herein by reference.

### TECHNICAL FIELD

This disclosure relates to a detection device, a management method and a communication apparatus.

### BACKGROUND

In the related art, a system that collects the data detected by a detection device on a server is known. For example, Patent Literature 1 (PTL 1) discloses a system that outputs the data measured by a measuring apparatus to a server by a terminal.

### CITATION LIST

### Patent Literature

PTL 1: JP2014-209311(A)

### SUMMARY

A detection device according to an embodiment of this disclosure includes a first sensor, a second sensor configured to operate with a power consumption smaller than that of the first sensor and a controller. The controller obtains a detection result from the second sensor while stopping the first sensor. When the detection result of the second sensor meets the first condition, the controller operates the first sensor and obtains a detection result from the first sensor.

A management method according to an embodiment of this disclosure obtains information about the size of article to be delivered as the first information. The management method obtains a free space in a storage of a delivery destination as the second information. The management method determines whether or not to deliver the article to be delivered to the delivery destination based on the first information and the second information.

The management method according to an embodiment of this disclosure accepts a request to deliver an article to a predetermined delivery destination. The management method obtains the free space in the storage of the delivery destination by the time the delivery of the article is completed.

A communication apparatus according to an embodiment of this disclosure includes a detector configured to detect the information contained in an absence notification. The communication apparatus includes a communication interface configured to send the information contained in the absence notification to an external apparatus when the detector detects the information contained in the absence notification.

### BRIEF DESCRIPTION OF THE DRAWINGS

In the accompanying drawings:

FIG. 1 is a block diagram illustrating a configuration example of a detection device according to an embodiment;

FIG. 2 is a perspective view illustrating a configuration example of a storage that stores an article;

FIG. 3 is a flowchart illustrating an example of a procedure performed by the detection device;

FIG. 4 is a diagram illustrating a configuration example of a management system outline according to an embodiment;

FIG. 5 is a block diagram corresponding to FIG. 4;

FIG. 6 is a flowchart illustrating an example of a procedure for managing delivery of an article;

FIG. 7 is a flowchart illustrating an example of a procedure for managing delivery of an article based on the information from a detection device of a delivery destination; and

FIG. 8 is a block diagram illustrating a configuration example of a communication apparatus according to an embodiment.

### DETAILED DESCRIPTION

With the spread of Internet of Things (IoT) technology, a detection device and an IoT unit can be combined. Various waste reductions are required in the detection of data in the detection device and management using the data.

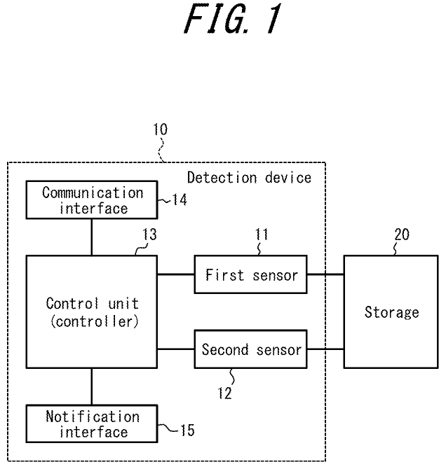

An embodiment of this disclosure will be described below with reference to the drawings. A detection device 10 (see FIG. 1) according to this embodiment can be used for IoT. The detection device 10 can be used not only for IoT, but also for other various applications.

As illustrated in FIG. 1, the detection device 10 according to an embodiment includes a first sensor 11, a second sensor 12 and a control unit 13. The detection device 10 may be connected to a storage 20. The detection device 10 may be configured integrally with the storage 20 or separately from the storage 20.

The first sensor 11 and the second sensor 12 can detect various kinds of information about the storage 20 when connected to the storage 20. Connection among the first sensor 11, the second sensor 12 and the storage 20 illustrated in the block diagram in FIG. 1 may represent that the first sensor 11 and the second sensor 12 are electrically connected or communicably connected to the storage 20. This connection may represent that the first sensor 11 and the second sensor 12 are attached to the storage 20, or the first sensor 11 and the second sensor 12 are provided in a predetermined positional relationship with respect to the storage 20.

The first sensor 11 and the second sensor 12 detect the information about a predetermined target. The target for which the first sensor 11 and the second sensor 12 detect information is also referred to as a detection target. The first sensor 11 detects more detailed information than that detected by the second sensor 12. On the other hand, the power consumption of the first sensor 11 is larger than that of the second sensor 12. In other words, although the second sensor 12 detects simpler information than that detected by the first sensor 11, it operates with power consumption smaller than that of the first sensor 11.

The first sensor 11 may be an image sensor such as a camera, or a sensor including a distance measurement sensor such as a Time of Flight (ToF) sensor, a proximity sensor, a gyro sensor or the like. The second sensor 12 may be, for example, an acceleration sensor, an illuminance sensor, a proximity sensor, a pressure sensor, a temperature sensor, a humidity sensor, a geomagnetic sensor, a gyro sensor, a gas sensor, or the like.

The control unit 13 outputs a control instruction to each component of the detection device 10 or receives various kinds of information from each component. The control unit 13 may have a memory. The memory may include a semiconductor memory, a magnetic memory or the like. The memory stores various kinds of information and program executed by the control unit 13. The memory may serve as a work memory of the control unit 13. The detection device 10 may include a memory separately from the control unit 13.

The control unit 13 is also referred to as a controller. The control unit 13 may include at least one processor to provide control and processing capacity to perform various functions. The processor can serve as a controller. The processor can execute a program that realizes various functions of the control unit 13. The processor may be realized as a single integrated circuit. The processor may be realized as a plurality of communicably connected integrated circuits and discrete circuits. The processor may be realized based on other various known technologies.

The detection device 10 may further include a communication interface 14. The communication interface 14 can realize various functions including wireless communication. The communication interface 14 may realize communication based on the Low Power Wide Area (LPWA) technology. The communication interface 14 may include communication interface such as the Local Area Network (LAN). The communication interface 14 may include contactless communication interface such as infrared communication or the Near Field communication (NFC). The communication interface 14 may realize communication by various communication methods such as 4G or the Long Term Evolution (LTE). The communication interface 14 may wirelessly communicate with an external device via an antenna.

The communication interface 14 may obtain the positional information of the detection device 10 based on the Global Navigation Satellite System (GNSS) technology and the like. That is, the detection device 10 may obtain the positional information of an own device. The GNSS technology may include satellite positioning systems such as the Global Positioning System (GPS), GLONASS, Galileo, Quasi-Zenith Satellite System (QZSS) and the like. The positional information of the detection device 10 may include latitude, longitude and altitude information.

The detection device 10 may further include a notification interface 15. The notification interface 15 notifies the user of the information based on a control instruction obtained from the control unit 13. The notification interface 15 may include a display device. The display device may be, for example, a Liquid Crystal Display, an Organic Electro-Luminescence (EL) display or an Inorganic Electro-Luminescence display or the like, but is not limited thereto, and may be other devices. The notification interface 15 may display characters or images on the display device based on the control instruction obtained from the control unit 13 to notify the surroundings of the information.

The notification interface 15 may include a light source such as a Light Emission Diode (LED) or a halogen lamp. The notification interface 15 may turn on or blink the light source based on a control instruction obtained from the control unit 13 to inform the surroundings of the information. The notification interface 15 may include a buzzer such as a piezoelectric buzzer or an electromagnetic buzzer, or a speaker that emits a predetermined sound. The notification interface 15 may sound a buzzer or generate sound from a speaker, based on the control instruction obtained from the control unit 13, to inform the surroundings of the information.

The storage 20 may be, for example, a post provided at a home of a general consumer or a delivery box. The storage 20 is not limited thereto, and may be various containers that can store an article 30. In the following description, the storage 20 is assumed to be a delivery box provided in a home of a general consumer.

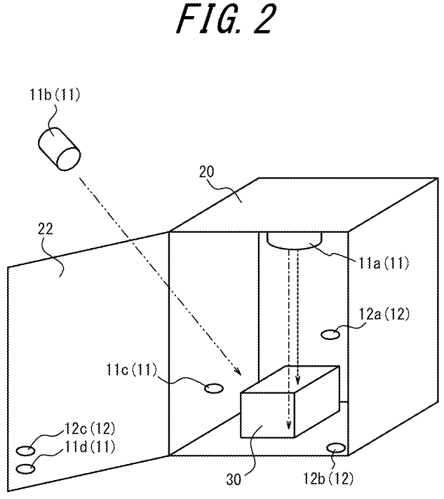

As illustrated in FIG. 2, the storage 20 can store the article 30. When the storage 20 is a delivery box, the article 30 is delivered as a delivery target and stored in the storage 20 of the delivery destination. The storage 20 may have a door 22. The first sensor 11 and the second sensor 12 of the detection device 10 according to an embodiment may be attached to the inside or the outside of the storage 20, or to the door 22. The first sensor 11 and the second sensor 12 may be provided to around the storage 20 or in a predetermined positional relationship with the storage 20.

The first sensor 11 and the second sensor 12 detect various kinds of information about the storage 20. In this case, the storage 20 is a detection target of the first sensor 11 and the second sensor 12. The control unit 13 obtains detection results from the first sensor 11 and the second sensor 12. If the first sensor 11 constantly or frequently detects information, the control unit 13 obtains detailed and large amount of detection results from the first sensor 11. However, when the state of the detection target of the first sensor 11 has not changed, the detailed and large amount of detection results of the first sensor 11 can be redundant data. That is, when the first sensor 11 is caused to detect information when the state of the detection target of the first sensor 11 has not changed, the detection results of the first sensor 11 may be wasted. It can be said that the operation of the first sensor 11 can be wasted. It can be also said that the power consumed by operation of the first sensor 11 can be wasted.

In this embodiment, the control unit 13 obtains detection result from the second sensor 12 while stopping the first sensor 11. When the detection result of the second sensor 12 meets the first condition, the control unit 13 operates the first sensor 11 to obtain detection result from the first sensor 11. The first condition may be that the detection result of the second sensor 12 represents a change in the state of the detection target of the first sensor 11. The first condition may be that the detection result of the second sensor 12 represents a possibility that the state of the detection target of the first sensor 11 has changed. When the control unit 13 operates the first sensor 11 based on the detection result of the second sensor 12, the detection result of the first sensor 11 is less likely to be wasted, and the operation frequency of the first sensor 11 can be reduced. When the operation frequency of the first sensor 11 is reduced, the amount of power consumption of the detection device 10 as a whole can be reduced. As a result, waste can be reduced. When the first sensor 11 is operated based on the detection result of the second sensor 12, compared with the case where the frequency of operating the first sensor 11 is simply reduced, the detection device 10 can detect the change in the state of the detection target in a timely manner and it is less likely that the detection device misses the change.

The control unit 13 outputs data based on the detection result of the first sensor 11 to the user. The control unit 13 may cause the communication interface 14 to send data to an external apparatus and may cause the notification interface 15 to notify the user of the data. Although the data to be output from the control unit 13 to the user can be composed based on the detection result of the first sensor 11, it is composed not based only on the detection result of the second sensor 12. It can be said that the first sensor 11 is a sensor that can obtain the data to be output by the control unit 13 to the user as a detection result. The second sensor 12 operates with less power consumption, and can detect simple information that does not constitute the data that is output by the control unit 13 to the user. On the other hand, the detection result of the second sensor 12 is used as a condition to determine whether or not to operate the first sensor 11.

The control unit 13 may output the information about the internal state of the storage 20 as the data based on the detection result of the first sensor 11. That is, the first sensor 11 may detect the internal state of the storage 20. The control unit 13 may output the information indicating that the article 30 is stored in the storage 20. The control unit 13 may output the information indicating that the free space in the storage 20 is less than the predetermined volume or is equal to or greater than the predetermined volume. When the first sensor 11 detects the internal state of the storage 20 as a detection target, the detection result of the second sensor 12 may indicate that whether or not the internal state of the storage 20 may have changed. When the first sensor 11 detects the internal state of the storage 20, the control unit 13 operates the first sensor 11 based on the detection result of the second sensor 12. In this manner, the control unit 13 can obtain the change in the internal state of the storage 20 in a timely manner and it is less likely to miss the change.

After operating the first sensor 11 based on the detection result of the second sensor 12, the control unit 13 may stop the first sensor 11 when the first sensor 11 finishes detection. The control unit 13 may determine if the first sensor 11 has finished detecting based on the detection result of the first sensor 11. The control unit 13 may determine that the first sensor 11 has finished detecting when the amount of data contained in the detection result of the first sensor 11 is equal to or greater than the predetermined amount. The control unit 13 may determine that the first sensor 11 has finished detecting when the first sensor 11 detects the detection result for a predetermined time or more. When the detection result of the first sensor 11 does not correspond to an error, the control unit 13 may determine that the first sensor 11 has finished detecting. When the first sensor 11 has finished detecting, the power consumption of the detection device 10 as a whole can be reduced by stopping the first sensor 11 again. As a result waste can be reduced.

The first sensor 11 can detect the internal state of the storage 20 regardless of whether or not the storage 20 stores the article 30. The internal state of the storage 20 may include whether or not the article 30 is present inside the storage 20. The internal state of the storage 20 may include the volume of space inside the storage 20 or the shape or the dimension of the space. The control unit 13 may obtain the size of the article 30 that can be stored in the storage 20 based on the detection result of the first sensor 11. The control unit 13 may obtain the volume, or the shape and the dimension of the article 30 that can be stored in the storage 20 based on the detection result of the first sensor 11.

When the first sensor 11 is a distance measurement sensor 11a, the distance measurement sensor 11a can detect the distance to the article 30 by a route illustrated by the arrowed broken line. When the distance measurement sensor 11a is located on the top surface of the storage 20, the distance measurement sensor 11 a can detect the distance from the top surface of the article 30 to the top surface of the storage 20. If the storage 20 does not store the article 30 and is empty, the distance measurement sensor 11a can detect the distance to the bottom of the storage 20 by a route illustrated by the arrowed dash-dotted line. The control unit 13 can obtain the internal state of the storage 20 based on the distance detected by the distance measurement sensor 11a. The control unit 13 can detect that the article 30 is stored in the storage 20 based on the distance detected by the distance measurement sensor 11a.

When the first sensor 11 is an image sensor 11b such as a camera, the image sensor 11b can take an image of inside the storage 20 from the viewpoint illustrated by the arrowed chain double-dashed line. The control unit 13 can obtain the internal state of the storage 20 based on an image in the storage 20 taken by the image sensor 11b. The control unit 13 can detect that the article 30 is stored in the storage 20 based on the image in the storage 20 taken by the image sensor 11b.

When the first sensor 11 is a proximity sensor 11c, the proximity sensor 11c may be located on each surface inside the storage 20. When the proximity sensor 11c is located on the bottom of the storage 20, it can detect that the article 30 is stored. When the proximity sensor 11c is located at a predetermined height on the side of the storage 20, it can detect that the article 30 above a certain height is stored. When the proximity sensor 11c is located on the top surface of the storage 20, it can detect that the storage 20 is filled with the article 30. The control unit 13 can obtain the internal state of the storage 20 based on the position of the proximity sensor 11c and the detection result thereof.

When the first sensor 11 is a gyro sensor 11d, the gyro sensor 11d may be located at the door 22 of the storage 20. The gyro sensor 11d can detect that the door 22 has been opened/closed. The control unit 13 can obtain the internal state of the storage 20 based on the information about movement of the door 22 detected by the gyro sensor 11d. The control unit 13 can detect that the article 30 is stored in the storage 20 based on the information about the movement of the door 22 detected by the gyro sensor 11d.

The first sensor 11 is not limited to the devices illustrated above, and may be configured by various devices or a combination of a plurality of types of devices.

The second sensor 12 can detect not only the internal state of the storage 20, but also various states such as an external state or the state around the storage 20. The control unit 13 determines if the internal state of the storage 20 may have changed based on the detection result of the second sensor 12. The control unit 13 stops the first sensor 11 if there is no possibility that the internal state of the storage 20 has changed. The control unit 13 operates the first sensor 11 if there is a possibility that the internal state of the storage 20 has changed.

When the second sensor 12 is an acceleration sensor 12c, the acceleration sensor 12c can detect the movement of the storage 20. For example, the acceleration sensor 12c can detect the vibration caused when the article 30 is stored in the storage 20. The control unit 13 may determine if the internal state of the storage 20 may have changed based on the movement of the storage 20 detected by the acceleration sensor 12c. For example, the control unit 13 may determine that movement has occurred in the storage 20 based on the fact that detection result of the acceleration sensor 12c has changed more than a predetermined value within a predetermined time, and may determine that the internal state of the storage 20 has changed based on the fact that movement has occurred in the storage 20. Further, for example, the control unit 13 may determine that the door 22 has opened/closed based on the detection result of the acceleration sensor 12c, and may determine that the internal state of the storage 20 has changed based on the determination that the door 22 has opened/closed. As illustrated in FIG. 2, the acceleration sensor 12c may be attached to the door 22, or to the other portions of the storage 20. The acceleration sensor 12c consumes little power when not detecting movement. Therefore power consumption of the acceleration sensor 12c is relatively small.

When the second sensor 12 is an illuminance sensor 12a, the illuminance sensor 12a can detect the change in the illuminance inside the storage 20. When the storage 20 has the door 22, the illuminance inside the storage 20 can be changed depending on the opening/closing of the door. The control unit 13 may determine if there is a possibility that opening/closing of the door 22 has occurred based on a change in the illuminance inside the storage 20 detected by the illuminance sensor 12a. The control unit 13 may determine if the internal state of the storage 20 may have changed based on the possibility that opening/closing of the door 22 has occurred. As illustrated in FIG. 2, the illuminance sensor 12a may be attached to the back surface of the storage space in the storage 20 or to other parts inside the storage 20.

When the second sensor 12 is a pressure sensor, the pressure sensor can detect the change in the pressure inside the storage 20. When the storage 20 has the door 22, the pressure inside the storage 20 can change depending on the opening/closing of the door 22. The control unit 13 may determine if there is a possibility that opening/closing of the door 22 has occurred based on the change in the internal pressure of the storage 20 detected by the pressure sensor. The control unit 13 may determine if there is a possibility that the internal state of the storage 20 has changed based on the possibility that opening/closing of the door 22 has occurred. The pressure sensor may be attached to the inside of the storage 20.

When the second sensor 12 is a temperature sensor, the temperature sensor can detect the change in the temperature inside the storage 20. When the storage 20 has the door 22, the temperature inside the storage 20 can change depending on the opening/closing of the door 22. The control unit 13 may determine if there is a possibility that opening/closing of the door 22 has occurred based on the change in the temperature inside the storage 20 detected by the temperature sensor. The control unit 13 may determine if there is a possibility that the internal state of the storage 20 has changed based on the possibility that opening/closing of the door 22 has occurred. The temperature sensor may be attached to the inside of the storage 20.

When the second sensor 12 is a proximity sensor 12b, the proximity sensor 12b can detect the opening/closing state of the door 22. For example, the proximity sensor 12b may be located so that it comes close to the door 22 with the door 22 closed. For example, the proximity sensor 12b can detect the opening/closing of the door 22 when the article 30 is stored in the storage 20. The control unit 13 may determine that if there is a possibility that the internal state of the storage 20 has changed based on movement of opening/closing the door 22 detected by the proximity sensor 12b. As illustrated in FIG. 2, the proximity sensor 12b may be attached near the closed door 22 or to the other parts of the storage 20.

When the second sensor 12 is a geomagnetic sensor, the geomagnetic sensor can detect the opening/closing state of the door 22. When the door 22 rotates around one side of as an axis of rotation, the orientation of the geomagnetic sensor may change as the door 22 rotates. The geomagnetic sensor may detect a rotation angle of the door 22 by detecting the geomagnetic direction with respect to the orientation of own device. The control unit 13 may determine if there is a possibility that opening/closing of the door 22 has occurred based on the rotation angle of the door 22 detected by the geomagnetic sensor. The control unit 13 may determine if there is a possibility that the internal state of the storage 20 has changed based on the possibility that the opening/closing of the door 22 has occurred. The geomagnetic sensor may be attached to the door 22.

When the second sensor 12 is a gyro sensor, the gyro sensor can detect the opening/closing state of the door 22. When the door 22 rotates around one side as an axis of rotation, the orientation of the gyro sensor can change as the door 22 rotates. The gyro sensor may detect the rotation angle of the door 22 by detecting the orientation of own device. The control unit 13 may determine if there is a possibility that opening/closing of the door 22 has occurred based on the rotation angle of the door 22 detected by the gyro sensor. The control unit 13 may determine if there is a possibility that the internal state of the storage 20 has changed based on the possibility that the opening/closing of the door 22 has occurred. The gyro sensor may be attached to the door 22.

When the second sensor 12 is a gas sensor, the gas sensor may determine if there is a possibility that the internal state of the storage 20 has changed by detecting the gas inside the storage 20. For example, when a cardboard box is stored as the article 30 in the storage 20, the gas sensor may detect the odor thereof. The gas sensor can detect the change of the article 30 over time by detecting the gas inside the storage 20. The gas sensor may be attached to the inside of the storage 20.

The second sensor 12 is not limited to the devices illustrated above, and may be configured by various devices or by a combination of a plurality of types of devices.

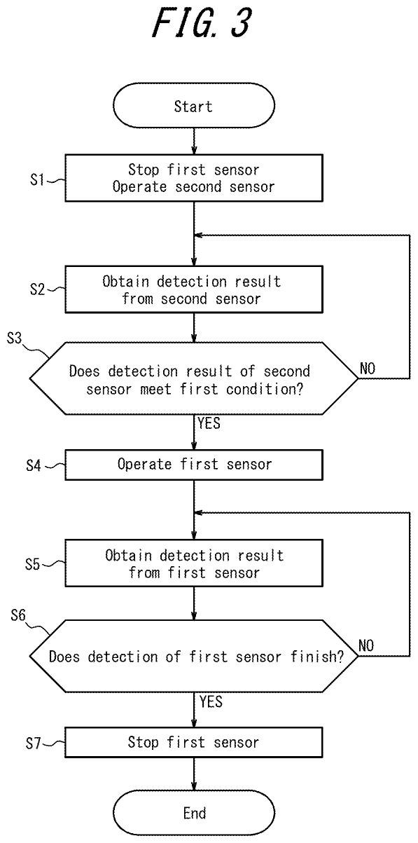

The detection device 10 according to an embodiment may detect the information of a detection target according to the procedure of the flowchart illustrated in FIG. 3.

The control unit 13 stops the first sensor 11 and operates the second sensor 12 (step S1). By operating only the second sensor 12 that operates with a relatively small power consumption, the power consumption of the detection device 10 as a whole can be reduced.

The control unit 13 obtains a detection result from the second sensor 12 (step S2).

The control unit 13 determines if the detection result of the second sensor 12 meets the first condition (step S3). When the detection target is the storage 20, the control unit 13 may determine if there is a possibility that the internal state of the storage 20 has changed. When the detection result of the second sensor 12 does not meet the first condition (No in step S3), the control unit 13 returns the procedure to step S2

When the detection result of the second sensor 12 meets the first condition (Yes in step S3), the control unit 13 operates the first sensor 11 (step S4).

The control unit 13 obtains the detection result from the first sensor 11 (step S5).

The control unit 13 determines if the first sensor 11 has finished detecting (step S6). When the first sensor 11 has not finished detecting (No in step S6), the control unit 13 returns the procedure to step S5.

When the first sensor 11 has finished detecting (Yes in step S6), the control unit 13 stops the first sensor 11 (step S7). When the first sensor 11 is stopped, the power consumption of the detection device 10 as a whole can be reduced. After step S7, the control unit 13 finishes the procedure of the flowchart illustrated in FIG. 3.

The detection device 10 according to this embodiment can reduce the power consumption amount of the detection device 10 as a whole by reducing the operating frequency of the first sensor 11 that operates with a relatively large power consumption. The detection device 10 increases the operating frequency of the second sensor 12 that operates with a relatively small power consumption and operates the first sensor 11 based on the detection result of the second sensor 12. In this manner, the detection device 10 can detect a change in the state of the detection target in a timely manner and is less likely to miss the change.

The detection device 10 may cause the first sensor 11 to perform calibration to obtain the internal state of the storage 20 with high accuracy. As the calibration, when the storage 20 is empty, the detection device 10 may cause the first sensor 11 to detect the internal state of the storage 20. The detection device 10 may recognize that the storage 20 is empty based on the user operation. The detection device 10 may recognize that the storage 20 is empty by including the other detection means. In this manner, the detection device 10 can obtain the internal state of the storage 20 with higher accuracy when the article 30 is stored in the storage 20. As calibration, the detection device 10 may confirm if the storage 20 is empty by causing the first sensor 11 to detect the internal state of the storage 20 at a predetermined timing. In this manner, even in the case where it is not determined that there is a possibility that the state has changed based on the detection result of the second sensor 12, regardless that the internal state of the storage 20 has actually changed, it is less likely that the change in the state of the detection target is missed.

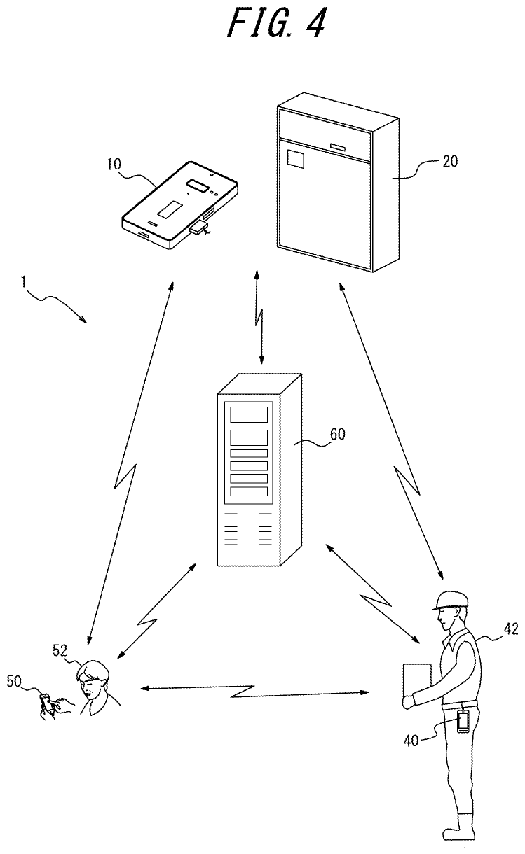

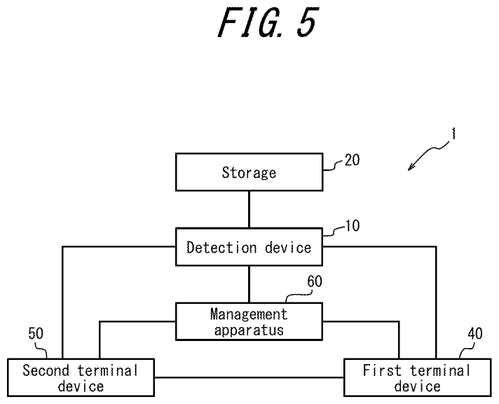

As illustrated in FIGS. 4 and 5, the management system 1 according to this embodiment includes the detection device 10 and a first terminal device 40. The detection device 10 and the first terminal device 40 are communicably connected to each other. The detection device 10 and the first terminal device 40 may be connected to each other over the network such as the Internet and the like.

The management system 1 may further include a second terminal device 50. The second terminal device 50 is communicably connected to the detection device 10 and the first terminal device 40. A management apparatus 60 may be connected to the detection device 10 and the first terminal device 40 over the network.

The management system 1 may further include a management apparatus 60. The management apparatus 60 is communicably connected to the detection device 10 and the first terminal device 40. When the management system 1 includes the second terminal device 50, the management apparatus 60 may be communicably connected to the second terminal device 50. The management apparatus 60 may be connected to the detection device 10, the first terminal device 40 and the second terminal device 50 over the network. The management apparatus 60 may be a server and the like.

In this embodiment, the management system 1 manages delivery of the article 30. The article 30 is delivered to a customer 52, which is a delivery destination, by a delivery company 42. The first terminal device 40 is owned by the delivery company 42. The second terminal device 50 is owned by the customer 52. The management system 1, the first terminal device 40 or the management apparatus 60 can perform the procedure relating to the management method of delivery of the article 30.

It is assumed that the storage 20 is a delivery box. It is assumed that the storage 20 is provided at a residence such as a home or a work place of the customer 52, or a stop such as a station or a shop. The storage 20 may be a property of the customer 52, or the customer 52 may have a usage contract thereof. When the storage 20 is related to the customer 52, which is a delivery destination, the storage 20 is also referred to as the storage 20 of the delivery destination. The detection device 10 is connected to the storage 20, and obtains the information about the internal state of the storage 20.

The delivery company 42 accepts a delivery request for the article 30 to be delivered. The delivery company 42 may accept a delivery request when the first terminal device 40 or the management apparatus 60 obtains the delivery request. The delivery company 42 may manually accept a delivery request at a counter. When manually accepting a delivery request, the delivery company 42 may input the delivery request to the first terminal device 40 or the management apparatus 60. The delivery company 42 may accept the delivery request and receive the article 30 to be delivered itself as well. When receiving the article 30 to be delivered itself, the delivery company 42 may input the information about the size of the article 30 to be delivered to the first terminal device 40 or the management apparatus 60. The information about the article 30 to be delivered is also referred to as the first information. The first terminal device 40 or the management apparatus 60 may obtain the first information with the delivery request. The first terminal device 40 may obtain the delivery request and the first information from the management apparatus 60. The management apparatus 60 may obtain the delivery request and the first information from the first terminal device 40.

The detection device 10 obtains the information about the size of the space that can store the article 30 in the storage 20 of the delivery destination. The size of the space that can store the article 30 is also referred to as a free space. The free space may include the volume of the space in the storage 20 of the delivery destination or the shape and the dimension of the space. The information indicating the free space in the storage 20 of the delivery destination is also referred to as the second information. The detection device 10 can obtain the second information at a variety of timings. The information indicating the free space in the storage 20 of the delivery destination obtained when the detection device 10 performs calibration is also referred to as the third information. The third information is the information indicating the free space in the storage 2 of the delivery destination at the time when the storage 20 of the delivery destination is empty. That is, the third information indicates specs of the free space in the storage 20 of the delivery destination. The third information is contained in the second information. The information indicating the free space in the storage 20 of the delivery destination obtained by the detection device 10 when it is unclear if the article 30 is accommodated in the storage 20 is also referred to as the fourth information. The fourth information is contained in the second information.

The detection device 10 outputs the second information to the first terminal device 40 or the management apparatus 60. When obtaining a delivery request, the first terminal device 40 or the management apparatus 60 may request the detection device 10 to output the second information. The detection device 10 may obtain the second information based on the request from the first terminal device 40 or the management apparatus 60. The first terminal device 40 may obtain the second information directly from the detection device 10 or indirectly via the management apparatus 60. The management apparatus 60 may obtain the second information directly from the detection device 10 or indirectly via the first terminal device 40.

The first terminal device 40 or the management apparatus 60 may determine whether or not to deliver the article 30 to be delivered to the delivery destination based on the first information and the second information. The first terminal device 40 or the management apparatus 60 may compare the size of the article 30 to be delivered with the free space in the storage 20 of the delivery destination, for example. The first terminal device 40 or the management apparatus 60 may determine that the article 30 to be delivered may be delivered when the size of the article 30 to be delivered is smaller than or equal to the free space in the storage 20 of the delivery destination. The first terminal device 40 or the management apparatus 60 may determine that the article 30 to be delivered is not delivered when the size of the article 30 to be delivered is greater than the free space in the storage 20 of the delivery destination. The first terminal device 40 may output the determination result to the management apparatus 60. The management apparatus 60 may output the determination result to the first terminal device 40. When the first terminal device 40 or the management apparatus 60 determines that the article 30 to be delivered may be delivered to the delivery destination, the delivery company 42 delivers the article 30 to be delivered to the delivery destination. When the first terminal device 40 or the management apparatus 60 determines that the article 30 to be delivered is not delivered to the delivery destination, the delivery company 42 does not deliver the article 30 to be delivered to the delivery destination. The delivery company 42 may recognize the determination result regarding the delivery availability by the first terminal device 40.

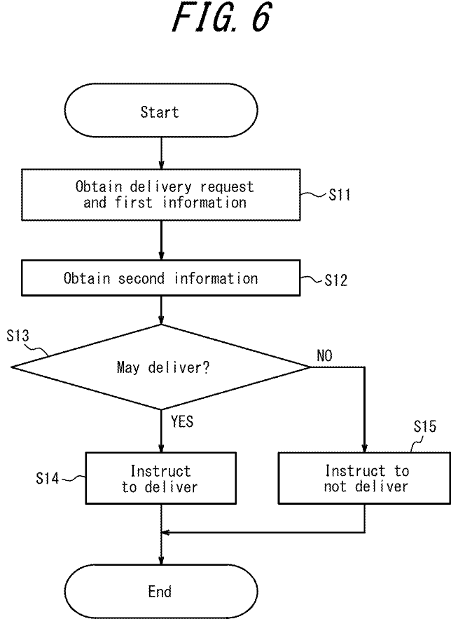

The first terminal device 40 according to an embodiment may manage the delivery availability of the article 30 to be delivered according to the procedure of the flowchart illustrated in FIG. 6. The procedure of the flowchart illustrated in FIG. 6 may be performed by the management apparatus 60.

The first terminal device 40 obtains a delivery request and the first information (step S11).

The first terminal device 40 obtains the second information (step S12). The second information obtained by the first terminal device 40 may be the third information or the fourth information.

The first terminal device 40 determines whether or not to deliver the article 30 to be delivered to the delivery destination, based on the first information and the second information (step S13). When obtaining the third information as the second information, the first terminal device 40 determines whether or not to deliver the article 30 to be delivered to the delivery destination based on the first information and the third information. In this case, the first terminal device 40 determines whether or not to deliver the article 30 to be delivered to the delivery destination based on the specs of the free space in the storage 20 of the delivery destination. When obtaining the fourth information as the second information, the first terminal device 40 determines whether or not to deliver the article 30 to be delivered to the delivery destination based on the first information and the fourth information. In this case, the first terminal device 40 determines whether or not to deliver the article 30 to be delivered to the delivery destination based on the current free space in the storage 20 of the delivery destination.

When determining that the article 30 to be delivered may be delivered to the delivery destination (Yes in step S13), the first terminal device 40 outputs an instruction to deliver the article 30 to be delivered to the delivery company 42 (step S14). After step S14, the first terminal device 40 finishes the procedure of the flowchart illustrated in FIG. 6. When the management apparatus 60 performs the procedure of step S14, the management apparatus 60 may output an instruction to deliver the article 30 to the first terminal device 40 to allow the delivery company 42 to recognize the instruction to deliver the article 30.

When determining that the article 30 to be delivered is not delivered to the delivery destination (No in step S13), the first terminal device 40 outputs an instruction to not deliver the article 30 to be delivered to the delivery company 42 (step S15). After step S15, the first terminal device 40 finishes the procedure of the flowchart illustrated in FIG. 6. When performing the procedure of step S15, the management apparatus 60 outputs an instruction to not deliver the article 30 to the first terminal device 40 to allow the delivery company 42 to recognize the instruction to not deliver the article 30.

According to the management system 1 of this embodiment, the delivery company 42 can deliver the article 30 after confirming the state of the delivery destination. In this manner, the probability that the delivery can be completed through a visit to the delivery destination can be increased. When the customer 52 of the delivery destination is absent or the free space in the storage 20 is insufficient even in the case where a visit to the delivery destination is made, the visit can be wasted. The number of visits to the delivery destination can be reduced by enabling confirmation of the situation of the delivery destination. As a result, a waste can be reduced. Here, the management apparatus 60 may be owned by the delivery company 42. The management apparatus 60 may also be owned by an internet mail-order company that accepts a purchase order of article 30 from the customer 52 over the Internet and requests the delivery company 42 to deliver the article 30. When detecting a purchase order of the article 30, the first terminal device 40 or the management apparatus 60 may obtain the first information about the size of the article 30 and the second information that indicates the free space in the storage 20 of the delivery destination registered in association with an orderer of the article 30. The first terminal device 40 or the management apparatus 60 may determine whether or not to deliver to the delivery destination of the article 30 based on the first information and the second information. As a result of determination, when it is determined not to deliver to the delivery destination of the article 30, the first terminal device 40 may output to the user the information indicating that the article 30 cannot be delivered. Alternatively, as a result of the determination, when it is determined not to deliver to the delivery destination of the article 30, the first terminal device 40 may cancel or invalidate the purchasing order of the article 30 and output the information to the user indicating that the order cannot be accepted.

In the management system 1 according to an embodiment, the first terminal device 40 or the management apparatus 60 may determine whether or not to deliver the article 30 to be delivered to the delivery destination at a predetermined timing from the start to the completion of delivery of the article 30 to be delivered by the delivery company 42. That is, the first terminal device 40 or the management apparatus 60 may determine whether or not to deliver the article 30 to be delivered to the delivery destination at least either one of start of delivery and during delivery. In this manner, when the article 30 cannot be delivered due to a change in the situation of the delivery destination after the delivery company 42 starts delivering and before the delivery company 42 actually visits, useless visit can be avoided. As a result, waste can be reduced.

When detecting a change in the internal state of the storage 20, the detection device 10 may notify the first terminal device 40 or the management apparatus 60 of the change. For example, the detection device 10 may notify the first terminal device 40 or the management apparatus 60 that the other article 30 different from the article 30 to be delivered is stored in the storage 20. When obtaining the notification after determining that the article 30 may be delivered, the first terminal device 40 or the management apparatus 60 may obtain again the second information from the detection device 10. The first terminal device 40 or the management apparatus 60 may determine whether or not to continuously deliver the article 30 based on the second information obtained again.

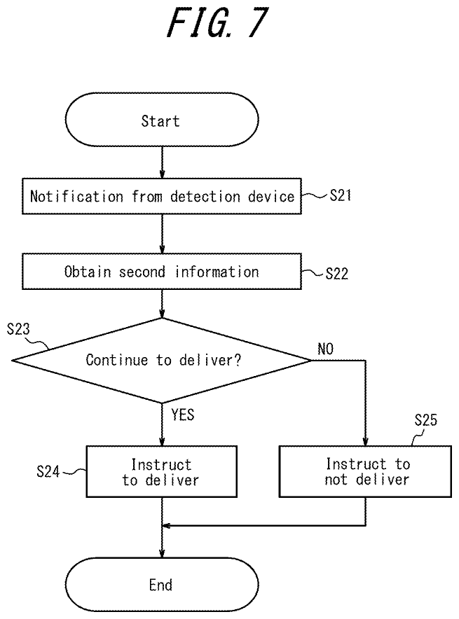

The first terminal device 40 may determine, with respect to the article 30 to be delivered during delivery, whether or not to continue its delivery, according to the procedure of the flowchart illustrated in FIG. 7. The procedure of the flowchart illustrated in FIG. 7 may be performed by the management apparatus 60.

The first terminal device 40 obtains, from the detection device 10, a notification indicating that the internal state of the storage 20 has been changed (step S21).

The first terminal device 40 obtains again the second information from the detection device 10 based on a notification from the detection device 10 (step S22).

The first terminal device 40 determines whether or not to deliver the article 30 to be delivered to the delivery destination based on the first information and the second information obtained again (step S23). The first terminal device 40 may perform the same or similar procedure as that in step S13 illustrated in FIG. 6.

When determining that the article 30 to be delivered may be delivered to the delivery destination (Yes in step S23), the first terminal device 40 outputs an instruction to deliver the article 30 to be delivered to the delivery company 42 (step S24). That is, the first terminal device 40 instructs the delivery company 42 to continue the delivery. After step S24, the first terminal device 40 finishes the procedure of the flowchart illustrated in FIG. 7. When the management apparatus 60 performs the procedure of step S24, the management apparatus 60 may allow the delivery company 42 to recognize the instruction to deliver the article 30 by outputting an instruction to deliver the article 30 to the first terminal device 40.

When determining not to deliver the article 30 to be delivered to the delivery destination (No in step S23), the first terminal device 40 outputs an instruction to not deliver the article 30 to be delivered to the delivery company 42 (step S25). That is, the first terminal device 40 instructs the delivery company 42 to stop delivering. After step S25, the first terminal device 40 finishes the procedure of the flowchart illustrated in FIG. 7. When the management apparatus 60 performs the procedure of step S15, the management apparatus 60 may allow the delivery company 42 to recognize the instruction to not deliver the article 30 by outputting an instruction to not deliver the article 30 to the first terminal device 40.

According to the management system 1 of this embodiment, the delivery company 42 can deliver the article 30 while confirming the change in the situation of the delivery destination. In this manner, the probability that the delivery can be completed through a visit to the delivery destination can be increased. As a result, waste can be reduced.

In the management system 1 according to an embodiment, the first terminal device 40 or the management apparatus 60 may obtain a delivery request to at least two delivery destinations. The first terminal device 40 or the management apparatus 60 may determine an order to visit the delivery destinations to deliver the article 30 to be delivered according to each delivery request, based on the content of delivery request. With respect to each delivery destination, the first terminal device 40 or the management apparatus 60 may determine whether or not to deliver the article 30 to be delivered. The first terminal device 40 or the management apparatus 60 may determine an order to visit the delivery destinations based on the determination result of the delivery availability to each delivery destination. The first terminal device 40 or the management apparatus 60 may determine the order to visit the delivery destinations based further on the position of the delivery destinations or the traffic situation around the delivery destinations. The order of visiting the delivery destinations is also referred to as the delivery order.

The first terminal device 40 or the management apparatus 60 may determine the time to visit the delivery destination based on the delivery order. The time to visit the delivery destination is also referred to as the delivery time. The first terminal device 40 or the management apparatus 60 may estimate the free space in the storage 20 of the delivery destination at the delivery time. The first terminal device 40 or the management apparatus 60 may estimate the free space in the storage 20 based on the result of the change in the internal state of the storage 20, for example. In this case, the detection device 10 may store the results of the change in the internal state of the storage 20 and output to the first terminal device 40 or the management apparatus 60. The first terminal device 40 or the management apparatus 60 may store the result of the change in the internal state of the storage 20 of the delivery destination. The first terminal device 40 or the management apparatus 60 may determine the delivery availability to the delivery destination at the delivery time, based on the estimation result. The first terminal device 40 or the management apparatus 60 may change the delivery order or the delivery time based on the determination result.

According to the management system 1 of this embodiment, the delivery company 42 can efficiently visit the delivery destination and reduce the number of visits until the delivery is completed.

In the management system 1 according to an embodiment, the detection device 10 may obtain the delivery order or the delivery time of the delivery company 42. The detection device 10 may estimate the change in the free space in the storage 20 based on the delivery order or the delivery time and output the estimation result to the first terminal device 40 or the management apparatus 60. In this manner, when a plurality of delivery companies 42 deliver an article 30 to be delivered to the storage 20 of the same delivery destination, duplication of deliveries by different delivery companies 42 can be avoided.

The detection device 10 may output the information about the internal state of the storage 20 to the second terminal device 50. The customer 52 can know the information about the internal state of the storage 20 through the second terminal device 50. When the article 30 to be delivered is stored in the storage 20, the customer 52 may know that the article 30 to be delivered has been delivered through the second terminal device 50. The customer 52 does not need to worry about when the article 30 to be delivered will be delivered or inquire about when the article 30 will be delivered by knowing that the article 30 has been delivered. As a result, waste can be reduced.

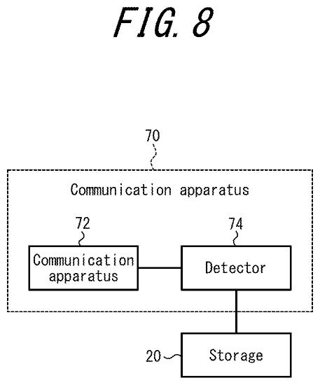

As illustrated in FIG. 8, a communication apparatus 70 according to an embodiment includes a communication interface 72 and a detector 74. The communication apparatus 70 may be provided in the storage 20 and connected to the storage 20. The management system 1 according to an embodiment may further include the communication apparatus 70. The management system 1 may include the communication apparatus 70 instead of the detection device 10.

The communication interface 72 can send the detection result by the detector 74 to an external apparatus and the like. The communication interface 72 may be configured to be the same as or similar to the communication interface 14.

The detector 74 can be connected to the storage 20 to detect the information about the internal state of the storage 20. The detector 74 may be configured to be the same as or similar to the detection device 10.

When not completing delivery of the article 30 to be delivered at the delivery destination, the delivery company 42 may notify the customer 52 that delivery could not be completed due to absence of the customer 52 or lack of the free space in the storage 20 and the like. The notification indicating that the delivery could not be completed is also referred to as an absence notification. The absence notification may contain the various kinds of information about delivery such as the information about the article 30 that could not be delivered or the information about redelivery.

The absence notification may be a slip and the like in which various kinds of information about the delivery is described in characters. The absence notification may be a slip and the like in which various kinds of information about the delivery is described in bar code or two-dimensional code, and the like. The absence notification may be a slip and the like such as an IC chip that stores various kinds of information about delivery.

The delivery company 42 may store an absence notification in the storage 20. The storage 20 may be a delivery box or a post. When the absence notification is stored in the storage 20, the detector 74 may detect a change in the internal state of the storage 20 to detect that the absence notification has been stored. When the detector 74 includes the first sensor 11 and the second sensor 12, the second sensor 12 may detect that the absence notification may have been stored and the first sensor 11 may detect that the absence notification has been stored in the storage 20. The detector 74 may obtain, by the first sensor 11, the information contained in the absence notification. When the absence notification contains the information described in characters, or the information described in bar code or two-dimensional code, the detector 74 may take an image of the absence notification. The detector 74 may output the information described in the absence notification to the communication interface 72, based on the image of the absence notification. When the absence notification contains the information stored in IC chip and the like, the detector 74 may read the information from the IC chip and the like to output to the communication interface 72. The delivery company 42 may cause the first terminal device 40 to directly output an absence notification to the detector 74. The detector 74 may output the information contained in the absence notification to the communication interface 72.

The communication interface 72 may send the information described or stored in the absence notification to the second terminal device 50 of the customer 52. In this manner, the customer 52 can receive the absence notification earlier. When receiving the absence notification earlier, the customer 52 can easily take an action such as requesting to redelivery, and the like. The customer 52 may output the information about redelivery from the second terminal device 50 to the first terminal device 40 or the management apparatus 60, based on the information contained in the absence notification. The first terminal device 40 or the management apparatus 60 may change the delivery order or the delivery time based on the information about the request to redeliver.

As a comparative example, suppose that the customer 52 confirms an absence notification stored in the storage 20 for the first time when taking it out from the storage. In this case, the customer 52 may feel inconvenience. For example, if the absence notification is confirmed outside the business hours of the delivery company 42 or after the deadline of accepting redelivery, the customer 52 may lose the opportunity to request the redelivery. On the other hand, according to the communication apparatus 70 of this embodiment, the customer 52 can confirm an absence notification earlier. When confirming the absence notification earlier, the customer 52 can request to redeliver earlier. When receiving a request to redeliver earlier, the delivery company 42 can easily review a delivery schedule. That is, delivery efficiency can be improved. As a result, waste can be reduced.

The communication interface 72 may directly communicate with the first terminal device 40 or the second terminal device 50 as they approach. The communication interface 72 may directly send the information about whether or not the article 30 is stored in the storage 20 to the first terminal device 40 or the second terminal device 50. For example, when the customer 52 passes in front of the storage 20, if the information indicating that the article 30 is stored is sent to the second terminal device 50, the customer 52 does not need to open the storage 20 when it is empty. For example, when the delivery company 42 comes close to the storage 20, if the information indicating that the article 30 is stored is sent to the first terminal device 40, the delivery company 42 does not need to open the storage 20 when the storage 20 has no free space. As a result, various wastes can be reduced. The communication interface 72 may detect that the first terminal device 40 or the second terminal device 50 comes close to the communication apparatus 70 using various known technologies. For example, the communication interface 72 may detect that the first terminal device 40 or the second terminal device 50 comes close to the communication apparatus 70 by a motion sensor included in the communication apparatus 70. For example, the communication interface 72 may detect that the first terminal device 40 or the second terminal device 50 comes close to the communication apparatus 70 based on successful automatic connection of near field communication to the first terminal device 40 or the second terminal device 50. The communication apparatus 70 may include the notification interface 15 that is the same as or similar to the notification interface 15 included in the detection device 10, and may cause the notification interface 15 to output the information about whether or not the article 30 is stored in the storage 20 when the first terminal device 40 or the second terminal device 50 approaches. If the article 30 is stored in the storage 20 when the first terminal device 40 or the second terminal device 50 approaches, the communication apparatus 70 may cause the notification interface 15 to perform a notification action. Although an example has been described where a determination of whether or not the article 30 is stored in the storage 20 is made based on the detection result of the distance measurement sensor 11a, the image sensor 11b or the proximity sensor 11c, the present disclosure is not limited thereto. The determination whether or not the article 30 is stored in the storage 20 may be made based on the detection result of the temperature sensor or the humidity sensor. Further, the storage 20 may be locked and unlocked, and the communication apparatus 70 may transit the storage 20 from the locked state to the unlocked state when the first terminal device 40 or the second terminal device 50 approaches. The state where the storage 20 is locked may be a state where the door 22 cannot be opened/closed, for example. The state where the storage 20 is unlocked may be a state where the door 22 can be opened/closed, for example. The communication apparatus 70 may determine that the first terminal device 40 or the second terminal device 50 comes close to the communication apparatus 70 based on a successful automatic connection of near field communication between the first terminal device 40 or the second terminal device 50 and the communication interface 72, for example.

In the management system 1 according to an embodiment, the delivery company 42 accepts a request to deliver the article 30 to a predetermined delivery destination. The first terminal device 40 or the management apparatus 60 obtains a request to deliver to the delivery company 42. The first terminal device 40 or the management apparatus 60 obtains the free space in the storage 20 of the delivery destination by the time the delivery company 42 completes delivery of the article 30. In this manner, the delivery company 42 can confirm the free space in the storage 20 by the time the article 30 is delivered. As a result thereof, the number of visits to complete the delivery can be reduced. That is, useless visit can be reduced. The first terminal device 40 or the management apparatus 60 may also determine, based on the free space obtained, whether or not to deliver the article 30, by the time the delivery company 42 completes delivery of the article 30. In this case, the first terminal device 40 or the management apparatus 60 may store a threshold to determine whether or not to deliver the article 30 in advance, and determine whether or not to deliver the article 30 based on the result of comparison between the threshold and the free space obtained.

In the management system 1 according to an embodiment, the storage 20 may be a trash can and the like provided in parks and the like. When the storage 20 is a trash can, the detection device 10 may detect the amount of trash in the trash can using a proximity sensor or a distance measurement sensor, for example. The detection device 10 may detect vibration occurred when trash is thrown into the trash can using an acceleration sensor, and operate the proximity sensor or the distance measurement sensor based on the detection result of the acceleration sensor. The detection device 10 may constitute the first sensor 11 and the second sensor 12 by various sensors.

A clerk collecting trash may own the first terminal device 40. The information about the amount of trash detected by the detection device 10 may be sent to the first terminal device 40. The clerk may confirm the amount of trash using the first terminal device 40 to determine when to collect the trash. The first terminal device 40 may determine when to collect the trash based on the amount of trash and instruct the clerk. In this manner, the possibility that the clerk goes to collect trash when no trash is in the trash can be reduced. As a result waste can be reduced.

Although this disclosure has been described on the basis of the drawings and the examples, it is to be understood that various changes and modifications may be made easily on the basis of this disclosure by those who are ordinarily skilled in the art. Accordingly, such changes and modifications are included in the scope of the disclosure herein. For example, functions and the like included in each function may be rearranged without logical inconsistency. A plurality of functions can be combined into one or divided. The above described each embodiment according to this disclosure is not limited to one that faithfully implements each embodiment described and may be implemented by combining each feature or omitting a part thereof appropriately.

In this disclosure, descriptions of “first” and “second” are identifiers for distinguishing configurations. In the configurations distinguished by the descriptions of “first” and “second” and the like, the numbers can be exchanged. For example, with respect to the first information and the second information, the identifiers of “first” and “second” can be exchanged. Exchange of identifiers is performed at the same time. The configurations are distinguished even after the identifiers are exchanged. Identifiers may be omitted. After identifiers are omitted, the configuration is distinguished by a reference sign. Order of the configuration and existence of low-numbered identifier shall not be determined only on the basis of description of identifiers such as “first” and “second” in this disclosure.

### REFERENCE SIGNS LIST

1 Management system

10 Detection device

11 First sensor

11a Distance measurement sensor

11b Image sensor

11c Proximity sensor

11d Gyro sensor

12 Second sensor

12a Illuminance sensor

12b Proximity sensor

12c Acceleration sensor

13 Control unit (controller)

14 Communication interface

15 Notification interface

20 Storage

22 Door

30 Article

40 First terminal device

42 Delivery company

50 Second terminal device

52 Customer at delivery destination

60 Management apparatus

70 Communication apparatus

72 Communication interface

74 Detector

1. A detection device comprising a first sensor, a second sensor configured to operate with power consumption smaller than power consumption of the first sensor and a controller, wherein
the controller obtains a detection result from the second sensor while stopping the first sensor, and when the detection result of the second sensor meets a first condition, operates the first sensor to obtain a detection result from the first sensor.

2. The detection device according to claim 1, wherein the first sensor obtains, as a detection result, information output by the controller.

3. The detection device according to claim 1, wherein the first sensor detects an internal state of the storage.

4. The detection device according to claim 3, further comprising a communication interface, wherein
the controller sends information about the internal state of the storage detected by the first sensor to an external apparatus by the communication interface.

5. The detection device according to claim 1, wherein the controller stops the first sensor when the first sensor finishes detecting.

6. A management method, comprising:
obtaining information about a size of an article to be delivered as first information;
obtaining a free space in a storage of a delivery destination as second information; and
determining whether or not to deliver the article to be delivered to the delivery destination, based on the first information and the second information.

7. The management method according to claim 6, comprising:
obtaining the free space in the storage of the delivery destination at a time when the storage of the delivery destination is empty as the second information; and
determining whether or not to deliver the article to be delivered based on the first information and the second information.

8. The management method according to claim 6, comprising:
obtaining the free space in the storage of the delivery destination at a time when a request to deliver the article to be delivered is accepted as the second information; and
determining whether or not to deliver the article to be delivered based on the first information and the second information.

9. The management method according to claim 6, comprising:
determining to deliver the article to be delivered to the delivery destination;
obtaining the free space in the storage of the delivery destination at a time of at least either one of start of delivery and during delivery of the article to be delivered as the second information; and
determining whether or not to continue delivering the article to be delivered based on the first information and the second information.

10. The management method according to claim 6, comprising:
detecting whether another article that is different from the article to be delivered is stored in the storage of the delivery destination;
obtaining, as the second information, a free space in the storage of the delivery destination at a time when another article that is different from the article to be delivered is detected to be stored in the storage of the delivery destination; and
determining whether or not to deliver the article to be delivered based on the first information and the second information.

11. The management method according to claim 6, comprising:
determining a time to visit the delivery destination when the article to be delivered is delivered to the delivery destination;
obtaining the free space in the storage of the delivery destination at the time determined as the second information; and
determining whether or not to deliver the article to be delivered based on the first information and the second information.

12. The management method according to claim 6, comprising:
obtaining information about a size of each article to be delivered to at least two delivery destinations as first information;
obtaining a free space in a storage of each delivery destination as second information; and
determining a delivery order of each delivery destination based on the first information and the second information.

13. The management method according to claim 6, comprising:
obtaining information about a size of each article to be delivered to at least two delivery destinations as first information;
obtaining a free space in a storage of each delivery destination as second information; and
determining a delivery time of each delivery destination based on the first information and the second information.

14. A management method, comprising:
accepting a request to deliver an article to a predetermined delivery destination; and
obtaining a free space in a storage of the delivery destination by the time when delivery of the article is completed.

15. The management method according to claim 14, comprising:
determining whether or not to deliver the article based on the free space obtained by the time when delivery of the article is completed.

16. A communication apparatus, comprising:
a detector configured to detect information contained in an absence notification; and
a communication interface configured to send information contained in the absence notification to an external apparatus when the detector detects the information contained in the absence notification.
